(19) United States
(12) Patent Application Publication
(10) Pub. No.: US 2007/0038673 A1
(43) Pub. Date: Feb. 15, 2007

(54) Method and apparatus for advanced shipping notification and EDI through web portal

(76) Inventors: Michael Clayton Broussard, Dallas, TX (US); Deanna Faye Herges, Mckinney, TX (US); John Stanley Phillips, Frisco, TX (US)

Correspondence Address: CARSTENS & CAHOON, LLP, P O BOX 802334, DALLAS, TX, 75380, US

(21) Appl. No.: 11/203,496

(22) Filed: Aug. 12, 2005

(51) Int. Cl. G06F 17/00

(52) U.S. Cl. 707/104.1

(57) ABSTRACT

Method and apparatus to facilitate the use of advanced shipping notification in commerce through a web portal, especially for direct store and cross dock delivery. Through a web portal, users transfer order information to business partners, generate serialized shipping container codes, generate and print container labels, and send and receive EDI communications. Through such portal, users assign items to individual containers, and generate and print corresponding labels having standardized information. Through such portal, orders are handled and processed more efficiently; reports are uploaded and shared; orders are tracked and audited; multiple suppliers may appear as one entity; and, multiple business partners and business partner locations receive standardized information about products or items, orders, and shipping containers. Through such portal, business partners provide feedback on any variances between advanced shipping notifications and items actually delivered. Such portal automates tasks traditionally performed by several systems and eliminates manual steps involved in delivering, tracking and auditing items such as goods.

### BACKGROUND

1. Technical Field

This invention relates to a method and software application for communicating with business partners, creating shipping labels, and creating documentation. More particularly, the invention relates to a method and system to aggregate order, product, electronic data interchange, and other types of information and communicate such information through a web portal complete with auditing functionality.

2. Description of Related Art

Many businesses use electronic data interchange (EDI) to send and receive business data including orders, invoices, and other transaction documents. Most industries benefit from reduced costs and increased business partner service satisfaction from the use of EDI and advanced shipping notifications (ASNs). Some businesses even provide EDI services through online interfaces. Further, certain patents and patent applications have disclosed concepts associated with online order fulfillment and related communications, but none meet the needs filled by the present invention.

For example, U.S. Pat. No. 6,505,093 issued to Thatcher et al., on Jan. 7, 2003 describes a method of automatically picking items to fill a purchase order. A purchase order is received electronically and information about the identity and quantity of items ordered in the purchase order is extracted from it. A pick list is generated and associated with a receptacle, such as a pallet for receiving picked items. Fulfillment items are placed in pre-designated carts. However, Thatcher '093 does not disclose the use of EDI or other similar communication means to provide shipping notice to business partners.

U.S. patent application having publication number 20030014270 by Qureshi et al. filed on Jul. 16, 2001 discloses and claims a supply chain management system. The invention includes a web portal application which imports and exports business data, and allows access to such data through a web browser. The Qureshi invention describes a generic means to generate and receive purchase orders, purchase order lists, bills of lading, packing slips, pick lists, and inventory lists. The Qureshi invention also discloses a browser-based secure web portal which provides a means to send and receive EDI communications. The portal allows users to generate and send ASNs and freight invoices to business partners. However, the application does not disclose any specific implementation, nor a means to match specific products to containers, and does not disclose a means for generating labels for containers for easier receiving at a delivery point.

U.S. patent application having publication number 20030069831 by Le et al. filed on Oct. 4, 2001 discloses a web based ordering software package especially for use in international transactions. Such package allows for electronic communication between retailers, wholesalers and manufacturers. Specifically, the Le application discloses a web based electronic transfer of replenishment orders from retailers. Messages are sent to a warehouse. The Le application does not describe EDI communications nor automatic generation of labels to be affixed to containers.

There does not exist in the prior art a method or apparatus for adequately facilitating order fulfillment, order tracking, order labeling, delivery of goods and auditing of the various stages of commerce between buyer and seller especially in the case of direct store delivery of goods and other types of commerce. Therefore, a need exists for a web-based application server whereby a user is able to upload orders, send and receive EDI communications, and generate and match labels to containers (e.g. carts, pallets, totes) which may be directly delivered to business partner warehouses, stores, and retail outlets in fulfillment of uploaded orders. A need exists to provide such services to a diverse and dispersed organization or collection of organizations. A need exists for a web-based application server through which auditing information may be easily exchanged between buyers and sellers. A further need exists for providing a means for many users or vendors, which may have a diverse set of computer environments and may be from various organizations with different infrastructures, systems capabilities, staffing and business cultures, to appear and interact as one consolidated user or vendor with buyers through a web portal. A need exists to generate SSCC labels and ASN data from either manual entry or automated feed of item-to-container assignments. A further need exists for printing SSCC labels from a standard Internet browser on a standard desktop or label printer. A further need exists for generating ASN data for EDI communications to trading partners or buyers. The present invention fills these and other needs as detailed more fully below.

### SUMMARY OF THE INVENTION

The object of the present invention is to facilitate the use of advance shipping notices (ASNs) in commerce through a web portal, especially for direct store and cross dock delivery of products to business partners. Users of such web portal include co-packers, suppliers, wholesalers, internal business partners, retailers and any other business partner. A web portal provides a means for users to upload, transfer, receive, and consolidate order information; generate or receive serialized shipping container codes; generate and print container labels; send and receive EDI communications; and receive notification when each step of the process is complete or requires attention. The web portal guides users through processes and steps based on uploaded product/orders and retail requests. Through such portal, a user or computer system assigns items to individual containers (e.g. pallets, carts, totes), and prints corresponding labels having serialized shipping container codes and other information. Such labels increase efficiency and accuracy of the delivery of products. Through such portal, orders are handled and processed more efficiently and uniformly. Through such portal, reports may be uploaded and shared, and orders may be tracked. Through such portal, auditing information may be uploaded, or may be entered directly through a web interface. Through such portal, multiple users may appear and be treated as one entity even though such users may have disparate computer systems and business environments. Through such portal, business partners send and receive standardized information about items, orders, and containers. Such portal automates tasks traditionally performed by several systems and eliminates manual steps in the process of selling and delivering goods.

The invention accordingly comprises the features described more fully below, and the scope of the invention will be indicated in the claims. Further objects of the present invention will become apparent in the following detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flow chart showing actors interacting with an ASN web portal according to the present invention within a typical direct store delivery process;

FIG. 2 is a flow chart showing the overall process for direct store delivery with use of an ASN web portal according to the present invention;

FIG. 3 is a schematic flow chart showing the general internal process of uploading an order to an ASN web portal and showing available functions which may be used with a valid uploaded order according to the present invention;

FIG. 4 is a flow chart showing detailed steps of validating an order and adding cross-reference data to an order record within an ASN web portal according to the present invention;

FIG. 5 shows one embodiment of an order processing screen according to the present invention from which many of the order functions are executed;

FIG. 6 shows one embodiment of an order detail screen according to the present invention in which items within an order may be reviewed, edited, added or deleted, and in which container assignments may similarly be reviewed, edited, added or deleted;

FIG. 7 shows one embodiment of a first page of a SSCC label generated by an ASN web portal according to the present invention;

FIG. 8 shows one embodiment of an optional page of a SSCC label generated by an ASN web portal according to the present invention;

FIG. 9 shows one embodiment of an order search results screen according to the present invention in which an ASN web portal lists orders meeting one or more search criteria;

FIG. 10 shows one embodiment of an order search results screen according to the present invention in which an ASN web portal lists orders meeting one or more search criteria; and,

FIG. 11 shows one embodiment of an auditing screen wherein variances between actual items and ASNs may be transmitted to an ASN web portal according to the present invention.

### ABBREVIATIONS

ASN Advanced Shipping Notice

DSD Direct Store Delivery

EDI Electronic Data Interchange

GLN global location number

GTIN global trade identification number

SKU Stock Keeping Unit

SSCC Serialized Shipping Container Code

SSL Secure Socket Layering

UPC universal product code

### DETAILED DESCRIPTION

While the invention is described below with respect to a preferred embodiment, other embodiments are possible. The concepts disclosed herein apply equally to other systems for providing advanced shipping notifications (ASNs) and EDI communications between business partners using a web portal, especially in conjunction with direct store delivery (DSD) of goods and cross dock. The invention also relates to creating serialized shipping container codes (SSCCs) which may be affixed to containers (e.g. pallets, carts, totes). Business partners may include co-packers, suppliers, wholesalers, retailers and internal business partners along with more traditional definitions. Throughout the description, suppliers are described, however a person having ordinary skill in the art will recognize that any business partner may use the web portal in the manner described. Suppliers are described as sending items, goods, or services to receivers which may be any business partner. The invention is described below with reference to the accompanying figures.

### OVERVIEW

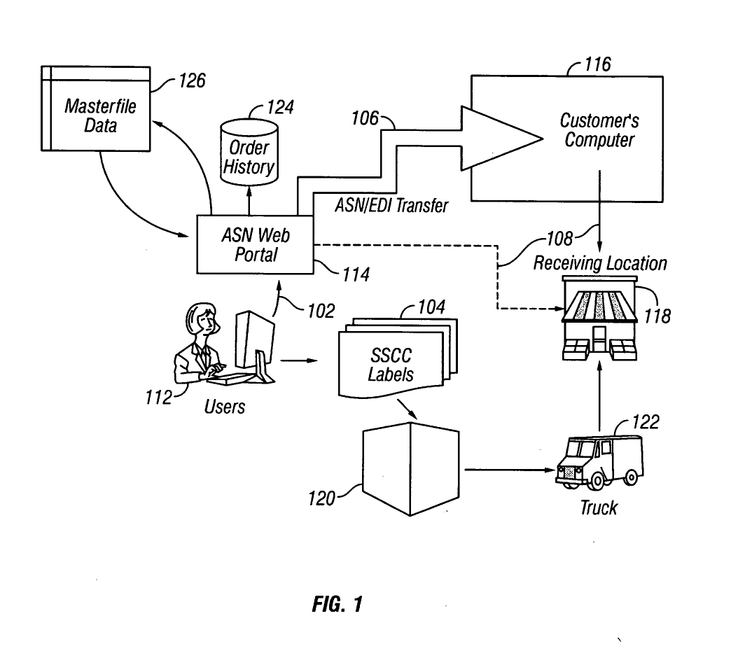

FIG. 1 illustrates one embodiment of the overall process of using a web portal to generate and send ASNs to business partners. In this embodiment, web portal suppliers are selling or transferring goods to another business partner. With reference to FIG. 1, a supplier 112 first receives and compiles an order 102 from one or more business partner requests (not shown). A user 112 uploads or transfers the order 102 to an ASN web portal 114. A transfer may involve transferring an order directly from one computer to the computer hosting the ASN web portal 114, and the transferring may not require a user. Such transfer may be automatic. Through an interface of the web portal 114, a supplier may assign products or items to containers, and generates and prints SSCC labels 104, which may contain scannable markings or codes. The labels 104 may be affixed to, or may accompany, containers 120 of items. These labels 104 also may be affixed directly to, or otherwise accompany, individual or boxed product packages.

An ASN web portal 114 sends an ASN data transfer 106 to a business partner's computer system 116. The computer system may be at a business partner's headquarters or central processing location wherein financial and inventory functions take place. The ASN data transfer 106 is sent as an EDI transfer, but alternatively may be in any electronic format. Optionally, the ASN data transfer 106 may first be sent to an EDI entity such as, but not limited to, a value added network (VAN), (depending on retailer or supplier requirements), an internal system, or to an AS/2 process before being sent onward to a business partner's computer system 106. In one variation, an ASN data transfer 106 is modified and/or formatted correctly by an EDI entity before being forwarded to the correct destination.

Next, a second data transfer or shipment communication 108 may be sent to the actual business partner location 118 from either the web portal 114 or through a business partner's computer system 116 depending on the wishes of the business partner. Such shipment communication 108 may contain some or all of the information in the first ASN data transfer 106. This shipment communication 108 comprises a record of what items, containers, SSCCs, and associated data, are to be delivered to a business partner location 118.

Separately, the containers 120 are delivered in a truck 122 or by other means to one or more business partner locations 118. Receiving staff of a business partner location 118 may accept the shipment as is, or may verify that the information in the shipment communication 108 exactly matches the quantity and type of actual goods delivered to the business partner location 118. Variations may be recorded in a business partner computer system. A business partner computer system may then send such information to the ASN web portal 114 in an auditing reply. Alternatively, any variations are communicated by other means (e.g. paper, file transfer) to a web portal user who then may manually enter the variations into the web portal 114.

In this fashion, an ASN web portal facilitates steps in the process of selling, tracking, delivering, and auditing of goods delivered to business partners and serves as a repository for reporting of analytics. Such ASN system provides increased accuracy and automation of tasks traditionally performed by several systems and personnel (e.g. clerks, receiving managers, deliverymen), and eliminates some or all of the manual steps in the process, including steps of manually entering data. The entire order-to-cash cycle can use the information to adjust and/or bill automatically in an improved pay-for-receipt system. The user sends shipment and billing information which more accurately reflects what is actually delivered to business partners. Business partners verify or audit what is delivered, and submit this information to the ASN web portal. The ASN web portal increases or improves the audit rate, the variation between what is communicated and what is actually delivered. The audit rate may be monitored for each business partner and each business partner location such that frequent or consistent errors may be identified and eliminated. Audit rates may be calculated as averages over days, weeks, months or other timeframe. Through the ASN web portal, more users including business partners and/or business partners are able to access an increasing amount of information associated with the process thus making the process more transparent. Users of various levels of technical ability are able to use the ASN web portal.

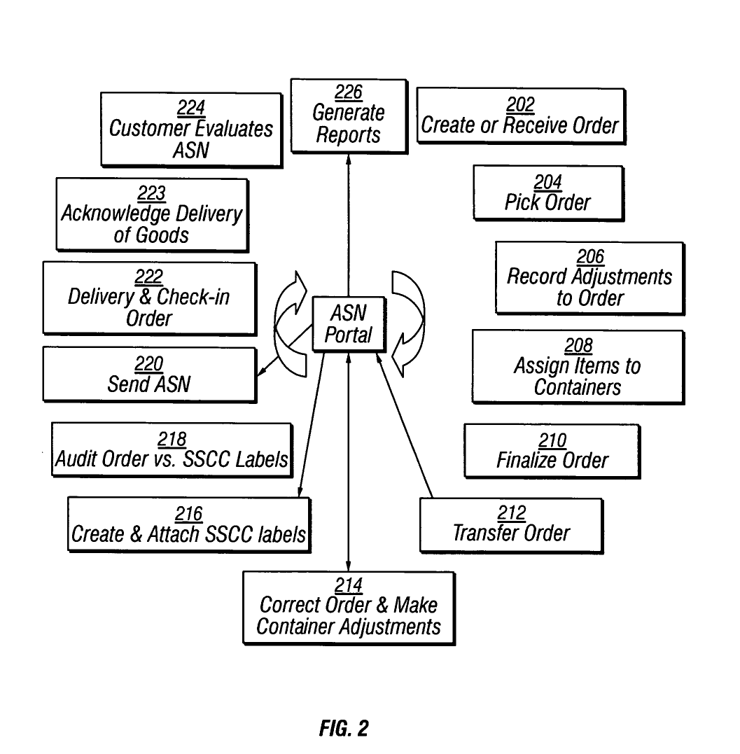

FIG. 2 shows a schematic of the overall method and process for creating and fulfilling orders for goods or services using ASNs and SSCCs for DSDs and other types of commerce. With reference to FIG. 2, a supplier starts by creating an order 202 and proceeding through the steps in a clockwise fashion. A supplier performs several steps before accessing or interacting with an ASN web portal. Such steps may include creating or receiving an order 202 in advance of delivery, having warehouse staff pick items for an order 204, recording any order picking adjustments 206, and recording item-to-container information 208. The steps of picking items 204, recording adjustments 206, and assigning items to containers 208 may be done in any order.

The next step is to finalize the order 210. This step may involve creating an order file. In such case, an order file may be created in two ways. First, a supplier may create an order file on a computer and upload or transfer the file to an ASN web portal. Second, a supplier may create an order file through an interface provided by the ASN web portal wherein the order file is created on a computer system directly allied with, or connected to, the computer hosting the ASN web portal thus obviating any need for uploading such file: the file in such case is submitted for further processing. There may be different means for creating such file, but an order file 210 has a standard format acceptable to a particular embodiment of an ASN web portal. Data in such order file should match the terms of an order including any adjustments made during the picking of the order.

Next, a supplier transfers a finalized order 212 to an ASN web portal and may include any item-to-container assignments and SSCC assignments. Alternatively, the order may be finalized and transferred without creating an order file. In this case, the finalized order may be directly transferred from an order management system, including a database or a web interface, without the need to create an order file. With such a direct transfer, the order is finalized 210 at the time the order is transferred 212. The transaction can be initiated by the web portal or may be initiated by the local computer system and received by the portal. Transfer includes any transmission of data including, but not limited to, uploading of data.

From the supplier interface to the ASN web portal, a user may update some information about an order such as, but not limited to, by making adjustments to item-to-container assignments 214. The ASN web portal ensures that the number of units assigned to containers is equal to the number of units uploaded in each order file.

After all details are final, a supplier may use the ASN web portal to create and print SSCC labels 216. Labels may be created without being printed. In an alternative embodiment, SSCC labels may be generated by a software component or other means external to, but connected to, the web portal. A supplier may affix printed SSCC labels to the physical containers to be delivered to business partners 218. Alternatively, any SSCC labels may accompany the containers during delivery. A supplier may verify that each container actually comprises the items corresponding to the information on each label. These labels contain information regarding item-to-container assignments. If any label information is incorrect, adjustments to the information on each label may be made by repeatedly revisiting the ASN web portal, and making adjustments to item-to-container assignments 214. Corrected SSCC labels 216 may be reprinted. SSCC labels may be given to a delivery person for verification and attachment at the delivery site, or may be verified and attached by order fillers at the source warehouse.

With reference to FIG. 2, a supplier may then send one or more ASNs through the ASN web portal 220 to one or more business partner computer systems for delivery to one or more receiving locations. Such transmission may be an EDI communication. The ASN web portal may receive one or more EDI communications in response. One such message is an EDI “220” error message which tells the web portal 220 that an error occurred and to retransmit the ASN. The ASN web portal receives and reports the status of each transmission, and stores and reports any error messages returned from a business partner's computer system. The ASN web portal saves ASN information for an ASN history which is preferably persisted for at least one year. At such time, the history may be archived to an archive database from which it may be independently accessed, or may be stored onto a long term storage medium.

With reference to FIG. 2, at the conclusion of the activities involving the ASN web portal, the next step is to deliver the containers to the corresponding receiving locations 222. In the final step, business partners receive the delivery and optionally evaluate 224 whether the ASN matches the SSCC labels and the goods actually delivered to the receiving location.

### ASN WEB PORTAL FUNCTIONALITY

In one embodiment, a user must logon through a security screen before accessing certain functionality of the ASN web portal. A security function may comprise several steps. Once a user enters a user ID and password, the ASN web portal reads stored user profile data with the user ID. If the user ID is valid, the ASN web portal makes available to other ASN web portal functions certain user profile information. If the user ID and password combination is valid, the ASN web portal presents an initial screen wherein orders may be listed. If the user ID and password combination is invalid, an error screen is presented in which a message is shown to a user. If a particular user ID is entered along with an incorrect password a certain number of times, the ASN web portal locks out the particular user ID for a predetermined amount of time and presents a corresponding error message to the user. During operation of a session with the ASN web portal, if a user does not perform any action within a predetermined amount of time, the ASN web portal logs off or ends the user's session. If a user is automatically logged off, completed steps or functions do not have to be repeated for a particular order. Before a user resumes work, a user must re-enter the appropriate correct user ID and password combination. User authentication and security may be implemented with SSL technology.

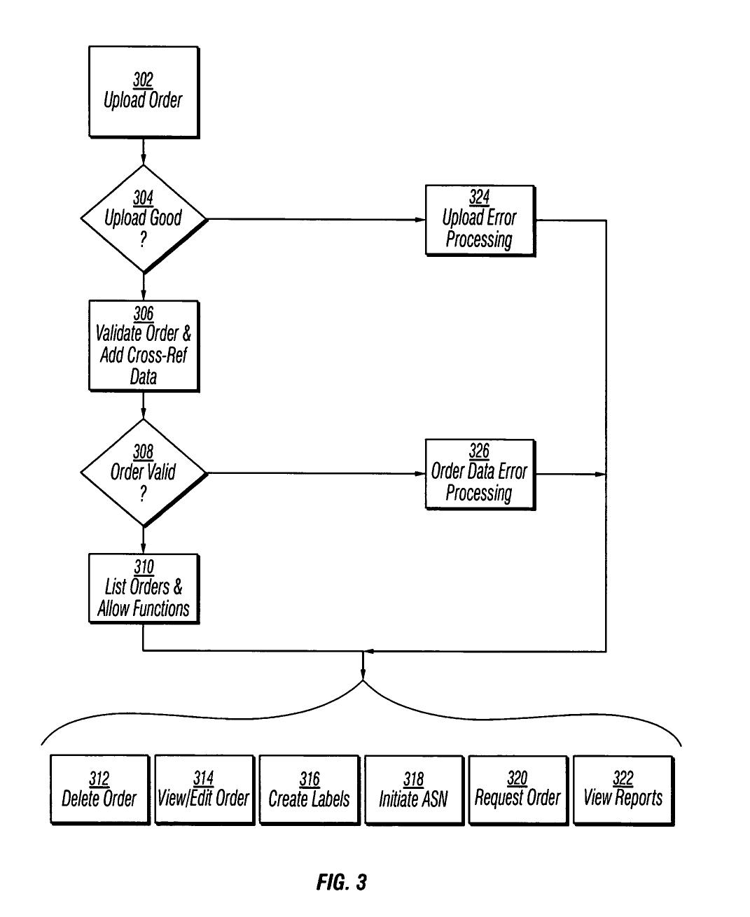

After a user securely logs into the ASN web portal, a user is presented with a principal user interface screen from which a user is required to transfer or upload an order if one does not already exist in the system. FIG. 3 shows a schematic flow chart of the overall process of transferring an order to an ASN web portal and accessing subsequently available functions. With reference to FIG. 3, an order is first transferred 302 to the system. Second, the ASN web portal determines if the transfer was valid 304. If not, the ASN web portal initiates transfer error processing 324, responds with an error message 328 to the user, and ends 330. If the transfer is valid, the ASN web portal next validates the order and adds cross-reference data 306. At this point, the ASN web portal validates the order 308. If the order is not valid, the ASN web portal initiates order data error processing 326 and displays an error message to the user. If the order is valid, the ASN web portal lists the order with the rest of any previously transferred or uploaded orders, and allows the user to access several functions 310 for that particular order.

Through the resulting screen, a user is able to access several functions in relation to orders including, but not limited to, view order & edit an order 314 (before submitting its corresponding ASN), delete an order 312 (before submitting its corresponding ASN), print order details, transmit or initiate an order's ASN 318, and print SSCC labels 320. A user may also request to transfer another order 320 and view reports 322. A user may only access orders for his organization or location depending on the how an administrator granted authorization. The web portal may be configured in a variety of ways to conform to the needs of the situation for each user.

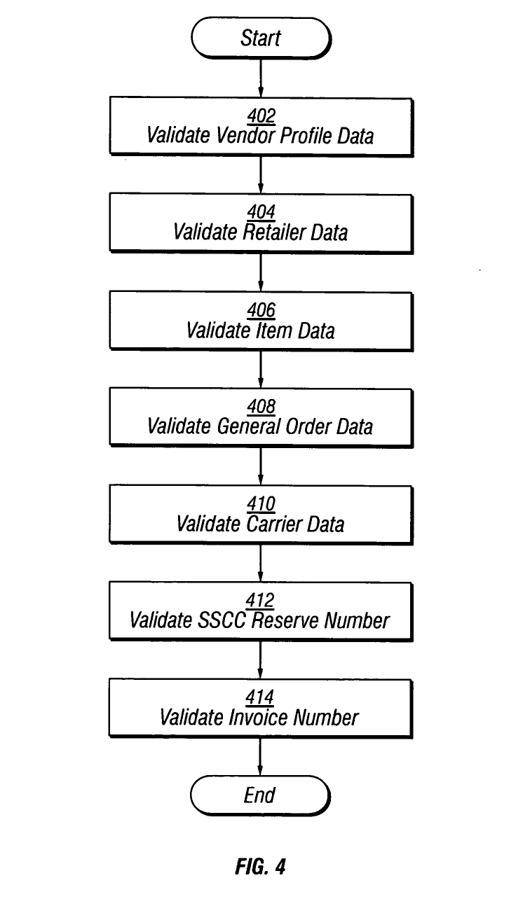

FIG. 4 illustrates the internal steps taken by the ASN web portal when validating an order as shown as part of the validate order and add cross-reference data step 306 in FIG. 3. If any of the steps are not passed, then an error results and the ASN web portal reacts accordingly. With reference to FIG. 4, the ASN web portal starts by validating user profile data 402. Next, the portal validates the retailer data 404. Subsequently, it validates item data 406, and general order data 408. The portal then validates any carrier data 410, SSCC reserve numbers 412, and invoice number 414. If the ASN web portal successfully validates these parts of an order, the order is considered valid and the ASN web portal continues the process shown in FIG. 3.

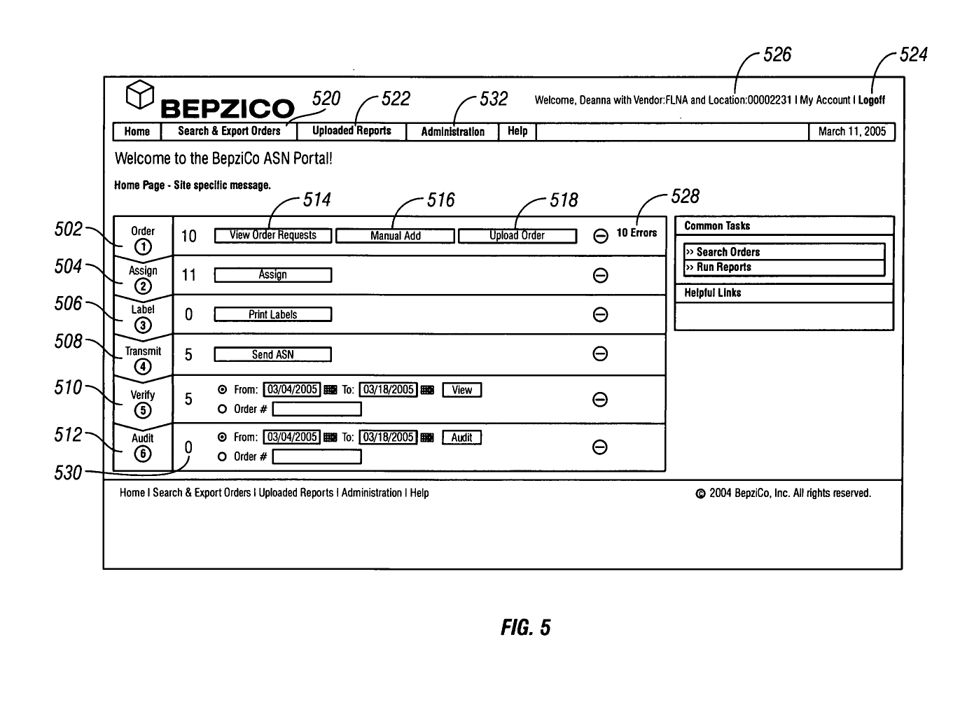

FIG. 5 illustrates one embodiment of such a principal user interface screen. With reference to FIG. 5, the interface is intuitively arranged so as to guide a user through the typical steps or stages of using the ASN web portal. The steps are labeled in order one through six. As each step is completed, one or more indicators of the row corresponding to the particular step may be color coded so as to visually indicate to a user that the particular step for the particular order has been successfully completed, or whether it has errors. The first step 502 is to enter and select a new order or select one or more existing orders. A user may select a button or other software means to view orders 514. Selecting such button loads an orders list screen wherein certain details of each order are shown including, but not limited to, order number, delivery date, business partner number, business partner name, route number, source (e.g. manually added, uploaded from file), order creation date and time, status, and any status notes.

In one embodiment, the particular user or location information 526 is listed near the top of the screen. Only orders belonging to a particular user (user ID or profile location) may be accessed through the ASN web portal at one time. When one or more orders are validated, if errors are present, the number of errors 528 is shown on the far right side of the order item step 502. The number of errors 528 is similarly shown for the other steps.

A user may either upload an order 518 with an order file, or manually enter an order 516 through the ASN web portal. An uploaded order may come from another computer system or from one or more files located on a local or remotely accessible computer. The ASN web portal may invoke the native file browsing mechanism of a user's computer to assist the user to locate the file. When the order is uploaded, it is validated. Any errors from such validation are reported back to the user on one of the screens. A user may attempt to fix the source of the error and re-submit or re-upload an order. If an order is manually entered and has an error, the ASN web portal indicates which field or fields are improper, and the portal allows a user to fix the errors in the fields.

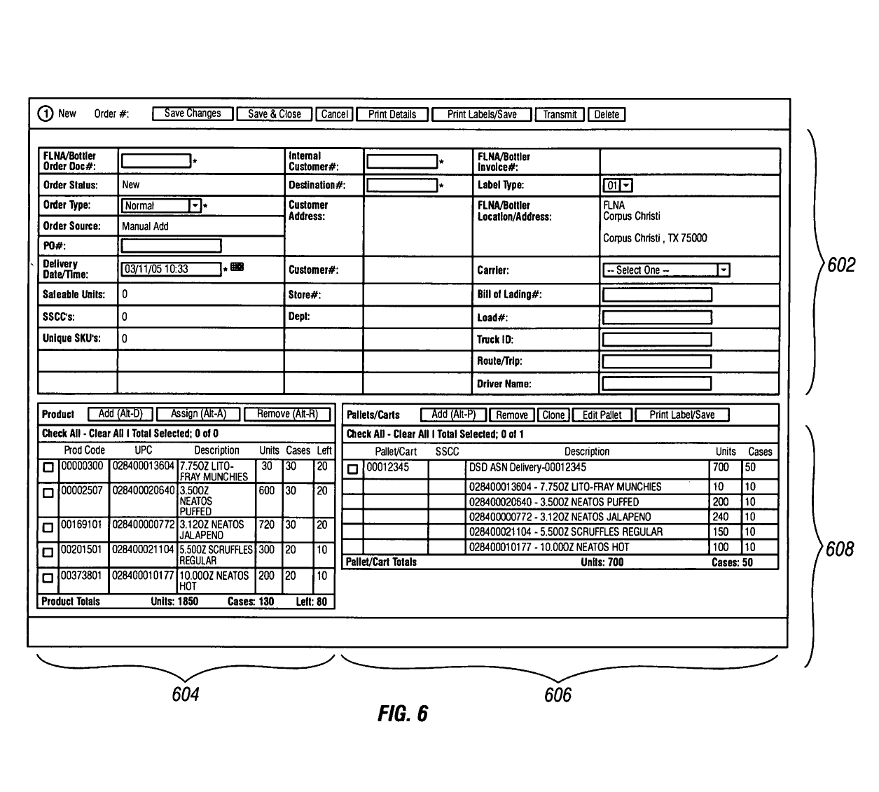

With reference to FIG. 6, uploaded orders contain order-specific information including such fields as, but not limited to, order document number, order type (e.g. normal, cross-dock), purchase order number, delivery date, internal business partner number, destination number, label type, carrier, bill of lading number, load number, truck ID, route or trip name, and driver name. After required information is entered into corresponding fields, specific items may be added to an order. In one embodiment, an add item button opens another window in which a user may add one item at a time by entering an internal item code, SKU, UPC, or a GTIN to identify the item, and a quantity (e.g. number of cases).

In one embodiment, and with reference to FIG. 6, an order detail screen shows order-specific information 602 in the top region of the screen, and products or items 604 and containers 606 belonging to that particular order in the lower portion 608 of the screen. Item information may include product code, SKU, UPC, description, number of units, and number of cases. The detail screen displays the total count of units and cases. A detail screen may also show container information such as container number (unique within each order), SSCC, description, number of units, number of cases, SKUs, and the total count of number of units, cases, and containers.

With reference to FIG. 5, the next step is to assign products 504 within an order to individual containers. A container may be any type of delivery cart including, but not limited to, pallets and totes. With reference to FIG. 6, a user may assign products to specific containers from the order detail screen. A user also may make modifications to such assignments as necessary until the corresponding ASN is submitted to a business partner. In one embodiment, when a user desires to add a container (through a button or other software means), the ASN opens a new form wherein is listed all products or items associated with the particular order. At the top of this form is listed the particular container number associated with the container. The user then selects the quantity of cases of each product to assign to each container. Once a user is finished making selections, a user may select a button or other software means whereby the ASN web portal saves the information and closes the form. The underlying order detail screen is then refreshed with the new information.

In one embodiment and with reference to FIG. 5 and FIG. 6, the assign items step 504 is complete when a user assigns all of the items for an order 604, which are listed on one side of an order details screen, to containers 606 listed on another side of the screen. In another embodiment, a clone container option allows a user to copy one container assignment to another newly created container. Such option provides a means to more quickly assign product to containers. An existing container assignment may be modified until the user is satisfied with the product to container assignment. Additionally, the ASN web portal provides a quick key function whereby a user may assign a product to a particular container merely by selecting the container, and then entering the product code and case quantity. Such function may be dependent upon whether the Internet browser being used supports such function. A user may thereby avoid scrolling through long lists of products while assigning products to containers.

With reference to FIG. 5, the next step or stage is to print SSCC labels 506 for each of the containers created in the assign containers step 504. This step is not necessary if labels are not required to be printed for proper delivery. Labels may be generated and printed from the product detail screen shown in FIG. 6. SSCCs may be generated from this or other screen if the SSCCs were not previously transferred with the other order data. The web portal ensures that SSCC numbers are unique for at least one year for each organization and destination or receiving location. The web portal indicates if the transferred SSCCs are not allowed or in error. In such case, the web portal provides a means to regenerate new, valid SSCCs.

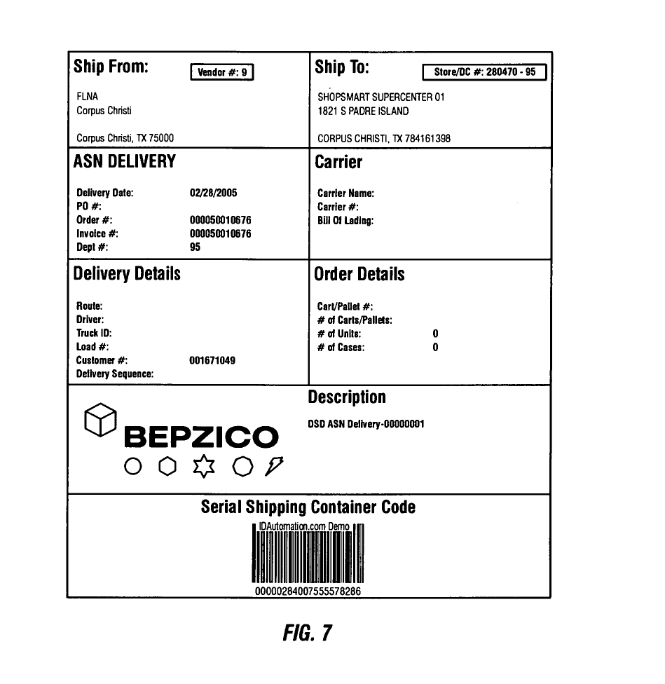

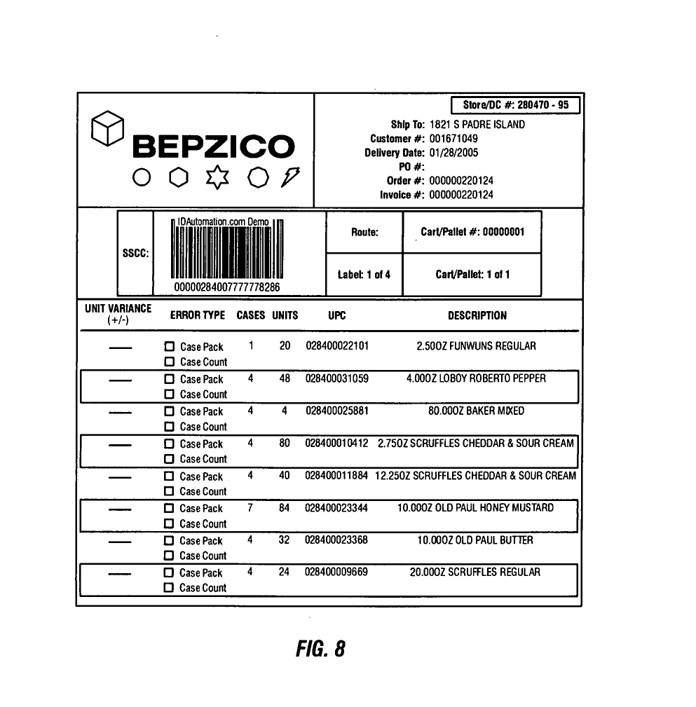

Once labels have been generated and/or printed for each container, the print label step 506 is complete. One embodiment of an SSCC label is two or more standard pages; examples of these pages are shown in FIG. 7 and FIG. 8. The web portal may allow various label formats as may be required by each business partner.

With reference to FIG. 7, the information may be divided into boxes within the label. In one box, may be “ship from” information such as, but not limited to, a name of an organization, a name of a person, an address, and user number. In another box may be “ship to” information such as, but not limited to, a name of an organization, a name of a person, an address, and any information identifying a business partner. In another box may be ASN delivery information including, but not limited to, delivery date, purchase order number, order number, invoice number, and department number. In another box there may be carrier information such as, but not limited to, carrier name, carrier number, and bill of lading information. In another box may be delivery details such as, but not limited to, route, driver information, truck ID, load number, business partner number, and delivery sequence. In another box may be order details such as, but not limited to, container number, number of containers (e.g. carts, pallets), number of units, and number of cases. In another box may be an order description including any specific DSD or ASN delivery information. Finally, the first page of a label may contain a SSCC.

With reference to FIG. 8, on optional second and subsequent pages of a label, there may be a box containing “ship to” address, business partner number, purchase order number, order number, and invoice number. In another box may be a SSCC in bar code form, route number, number of labels, and number of containers. In the remainder of the label, there may be a list of products. Such list of products may contain such information to assist in the business partner check-in process and includes, but is not limited to, blanks for unit variance and error type, number of cases, number of units, UPC, and product description.

With reference to FIG. 1, once labels are printed, a supplier may use the ASN web portal to transmit an ASN to a business partner's computer 116 corresponding to the transmit step 508 in FIG. 5.

### AUDITING FUNCTIONS

In another embodiment, an ASN web portal provides auditing functionality. With reference to FIG. 5, once a DSD is performed, a user may then verify delivery information 510. Through the ASN web portal, a user is able to perform a simple search for a particular order by order number, or by date or date range. The ASN web portal also provides an advanced search capability for orders and corresponding ASNs. In one embodiment, a user may search the past two years of orders and corresponding ASNs by any one or more of the following search criteria: delivery date, internal business partner number, business partner name, purchase order number, order document number, business partner GLN, carrier number, internal business partner number, internal destination number, order status, store number, and department. In such searches, a delivery date is required, but it may be a wide range of dates.

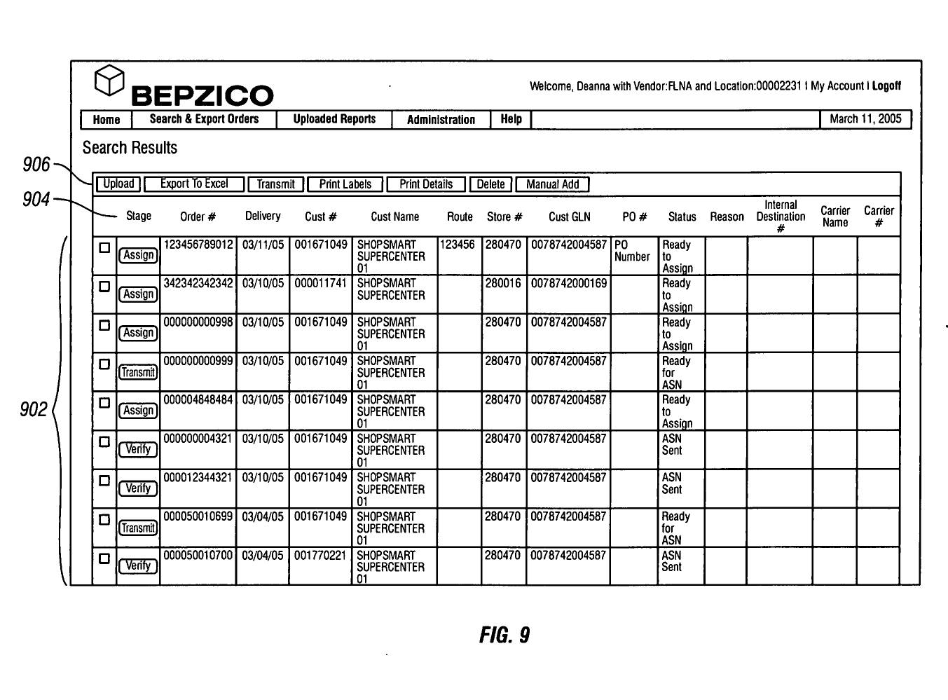

With reference to FIG. 9, once one or more orders are found, the ASN web portal presents the orders in list form 902. In one embodiment, certain information from each order is presented and may comprise order number, delivery date, business partner number, business partner name, route number, store number, business partner GLN, purchase order number, and status. A header row 904 describes the fields presented from each order. In one embodiment, certain functions may be performed on one or more orders. Such functions may be accessed through buttons 906 or other software means. In one embodiment, a user selects the checkbox for one or more orders and then selections a function to perform on these orders. For example, a user may export order information in a file format compatible with spreadsheet programs, reprint order labels, or print order details. An authorized user may delete one or more order records. Such order information may be used for further auditing functions. A user may extract various summaries of selected orders.

With reference to FIG. 5, a user may upload a report 522 associated with one or more orders or ASNs. A report 522 may include retailer's audit rates. In one embodiment, the ASN web portal stores all versions of reports so that a user may follow the historical changes to a particular report. In another embodiment, a user is given the option to keep or discard a previous version of a report. In another embodiment, only certain authorized users may have access to a report or to the history of a report. In a further embodiment, reports are secured reports which are available for viewing by authorized users. When a report is uploaded, it may be in any file format. At upload time, a report date is assigned to the report, such date subsequently may be modified.

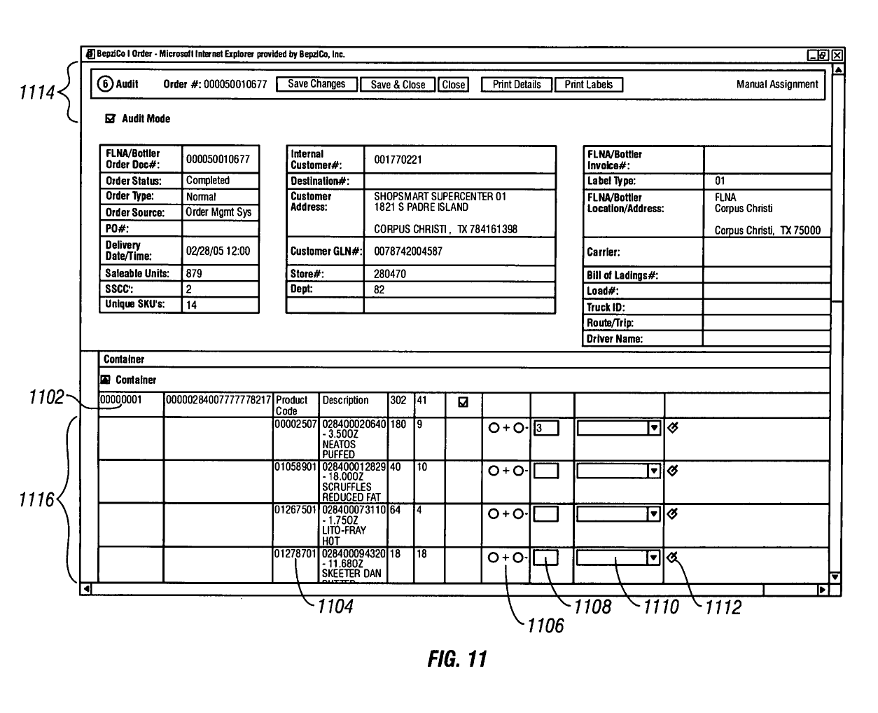

With reference to FIG. 5, the last step in the business process cycle performed through the ASN web portal is an audit function 512. Once one or more reports are found, the ASN web portal may allow an authorized user to review order and ASN information for auditing purposes. The ASN web portal allows a user to enter audit information directly into a form, or to selection an option to upload or receive audit information directly from a business partner's computer system. The method of performing an auditing function depends on the capability of a business partner's computer system. Auditing an order and corresponding ASN comprises recording the variance between the number of units of items actually delivered on each container within a particular order as compared to what was contained on the original order and corresponding ASN. Auditing also may include recording the error type and a description of each error. The ASN web portal provides a form in which these auditing functions may be performed. FIG. 11 shows one embodiment of such a form. Specific audit information may be saved and associated with ASN details by the web portal. Such information is made available through the ASN web portal for reporting and further analysis.

### SERVER ADMINISTRATION

An ASN web portal provides means for performing internal functions which are associated with, and necessary for, the external functions available to typical users of the ASN web portal. In one embodiment, an ASN web portal may provide a means to generate and print management reports, facilitate administrative functions, and allow loading of master files. Master files contain data which cross-references one physical store product record with reference information specific to the supplier or supplier's location. Further, an administrator may upload and validate master data, and enter audit information for one or more ASN orders. With reference to FIG. 5, administration functions are accessed by selecting an administration link or button 532 from the principal form. Configuring and uploading of information about users and business partners is considered “on-boarding” of data and part of the necessary setup or configuration of the ASN web portal prior to its proper operation.

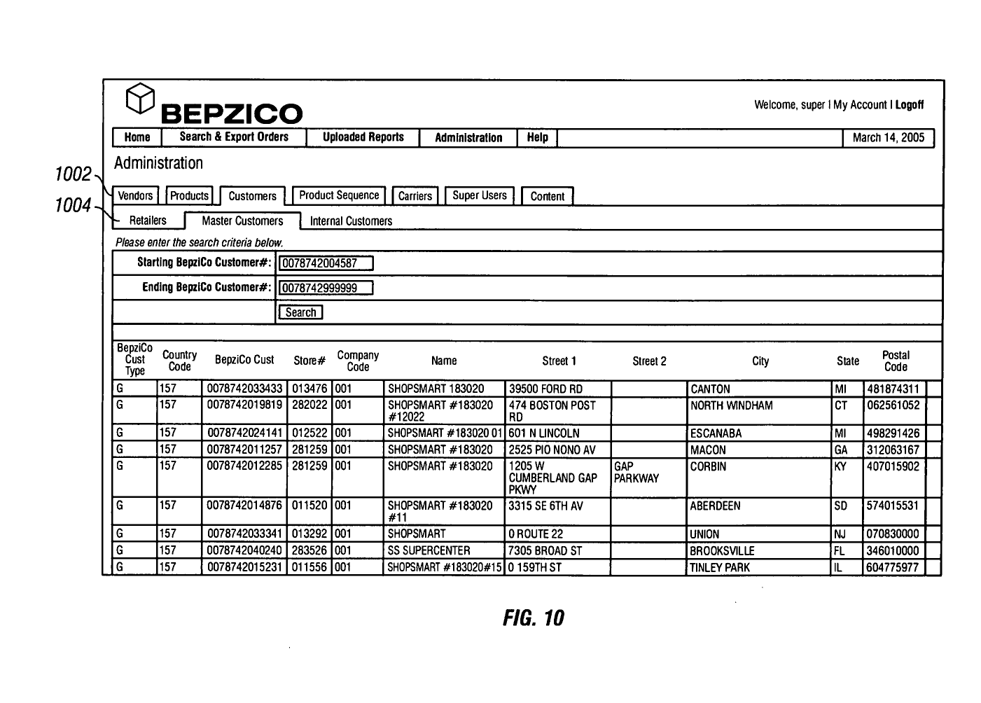

FIG. 10 illustrates a typical embodiment of one of the administrative forms. With reference to FIG. 10, a first row of buttons, links or other software means 1002, each corresponding to one or more administrative functions, divides the administrative functions into manageable and intuitive parts. A second row of functions 1004 may further divide each function into subtasks or smaller parts. In one embodiment, a first row of administrative functions may comprise the functions of setting up respectively users, items, business partners, item sequence, carriers, super users, and content. By selecting one of these buttons or links 1002, a user accesses a corresponding administrative form.

From a user form, an authorized user may manage a list of authorized ASN web portal users. It is this list or partial list of users which may appear as just one seller or user to a business partner. New users may be added to the list; existing users may be deleted. Similarly, an item administrative form allows a user to enter, maintain and view a list of items or products which are available to users of the ASN web portal. Item details may be manually entered or loaded in a batch mode through an upload function.

Items may be split into master items and internal items. These lists may be maintained separately. Lists of items and corresponding item information are set up one time for the ASN web portal. Identical item names and corresponding item information then may be shared with every business partner ordering the item. Further, identical item information then may be available to all ASN web portal users. As all involved suppliers and customers work with one master list of items, there is less chance for confusion and error. Further, a current list of available items may more easily be maintained. Master item information may include: item GTIN, item UPC, and a description. Internal item information may include: supplier name, supplier location, internal item code, case quantity, GTIN, and UPC.

In one embodiment, and with reference to FIG. 10, through a business partner form a user may maintain separate lists of business partner information. Such information may include, but is not limited to, a list of retailers, a list of master business partners, and a list of internal business partners. Information specific to each retailer who is to receive ASNs is input into the ASN web portal one time during setup. Retailer information may include fields such as, but not limited to, retailer chain ID, retailer chain name, and EDI destination number. Master business partner information may include fields such as, but not limited to, business partner type, country code, business partner number, store number, company code, business partner name, business partner street name, business partner city, business partner state, and business partner postal code. A user may manually enter information for each business partner or may load a batch of business partners and associated information through an upload function of the ASN web portal using a file containing such information in a standard format understood by the portal.

### DATA FORMATS

With reference to the upload order file step 212 in FIG. 2, one embodiment of an upload order file may comprise a header record, one or more item records, one or more item grouping records, one or more miscellaneous data records (containing for example a common carrier code), and one or more trailer records. Such records may have fields of any length. Preferred embodiments of these records are described here. Such records may be separated by line breaks or carriage returns.

One embodiment of a header record is indicated by a header record flag such as “H”, and such record comprises the fields as shown in Table 1. In one embodiment, an item record is indicated by an item record flag such as “P” and such record comprises the fields as shown in Table 2. An item record flag filed may be size 19. An optional item grouping record may also comprise such fields as an Internal Grouping Code or Container Number of field length 6, and SSCC Number of field length 20. Additional fields in an upload order file may include a Standard Carrier Abbreviation Code (SCAC) having a field length of 4, and a Cross-Dock Flag having a field length of 1. Additional fields are possible. One embodiment of a web portal is able to accept an upload order file which has these and additional fields. Upload order files may have an optional trailer record having a trailer record flag such as “T” and may contain the following fields with their respective record size in parentheses: bottler name (10), bottler location such as logistics ID or physical location (8), order number (20), message code (2), and message (60), wherein order number is a mandatory field. A trailer record flag field may be up to 60 in size.

TABLE 1
Header Record - “H”

| | Field | |
|---|---|---|
| Field Name | Length | Note |
| Bottler Name | 10 | |
| Bottler Location | 8 | Logistics ID, physical location |
| Order Number | 20 | Mandatory |
| Internal Business partner | 9 | Accords with user's system |
| Number | | |
| Business partner | 8 | |
| Destination | | |
| Business partner GLN | 13 | |
| Business partner's | 6 | Optional if data comes from Bottler |
| Department Code | | business partner-specific master file; |
| | | otherwise, if GLN is provided it is |
| | | required |
| Purchase Order Number | 20 | Optional for DSD |
| Purchase Order Date | 8 | |
| Total Header Quantity | 9 | |
| Order Delivery Date | 8 | Mandatory; format = YYYYMMDD |
| Order Delivery Time | 5 | Optional; format = HH:MM |
| Order Invoice Number | 20 | |
| Pallet | 20 | |
| SSCC | 20 | |

TABLE 2
Item Record - “P”

| | Field | |
|---|---|---|
| Field Name | Length | Note |
| Bottler Name | 10 | |
| Bottler Location | 8 | Logistics ID, physical location |
| Order Number | 20 | Mandatory |
| Internal Country or Company | 6 | |
| Item Number | | |
| Internal Item Code | 20 | |
| Item Case | 20 | |
| UPC | 12 | |
| GTIN | 14 | |
| Quantity | 8 | Mandatory |

A user may be required to perform different finctions to validate a particular order depending on the data elements found within the particular order file uploaded into the ASN web portal. Table 3 shows the particular required functions for each of six variations of acceptable order data within an uploaded order file according to one embodiment of the invention. In Table 3, the data fields are the columns for each option. In Table 3, U represents that the data field for the particular option is uploaded within the order data; S represents that the web portal determines or calculates the initial value of the particular data field, a system value, and that the value may be subsequently modified; P represents that the data field must be entered via the web portal, a user entry; D represents that the data field may be adjusted after the upload and listing on the web portal is complete; and, N/A represents that the data field is not applicable to the particular upload option.

TABLE 3
Upload Data Options

| | | User | | Internal | |
|---|---|---|---|---|---|
| Data Upload | SSCC | Container | | User | |
| Option | Number | Number | UPC/GTIN | Item Code | Quantity |
| 1 | S | P | S | U | U, D |
| 2 | S | P | U | N/A | U, D |
| 3 | S | U | S | U | U |
| 4 | S | U | U | N/A | U |
| 5 | U | N/A | U | N/A | U |
| 6 | U | N/A | S | U | U |

In one embodiment, a user creates an order file containing the ASN order details on a computer workstation in a standard file format such as in a comma-delimited text file. A web portal user then signals the web portal to upload the file through a secure internet connection.

In another embodiment, a user signals the web portal to upload an order including the ASN order details from a central order database. To accomplish this automation, a user is required to enter an order number. The web portal uses the order number as a database key to access the order details from a central order database. The database may belong to a business partner or to a user or user's employer. More than one order number may be submitted simultaneously. The web portal accesses each order sequentially so as to treat each order independently of the others. The web portal refreshes the browser display upon completion of its tasks, or upon the expiration of a pre-determined time limit for each order. If the web portal does not successfully connect to a central database and upload the information, it refreshes the display with an error message for each order.

In a further embodiment, a web portal cross-references an order number with an invoice number. A flag in a user profile determines if an ASN must wait for the web portal to perform such a cross reference.

In another embodiment, a web portal may update or merge an existing order with new information found in a newly uploaded order file having matching order fields. As the web portal processes such a file, each existing item entry which is updated (e.g. a change in quantity) is highlighted when the entire order is again displayed to a user. A user may then verify which fields are modified. In this embodiment, a user does not unknowingly lose previously submitted order information. At the time a new order file is uploaded which corresponds to an existing order, the ASN web server may present a user with one of several options including: deleting the previously uploaded order, merging the new order with the existing order, and canceling the upload request of the new order.

In a preferred embodiment, a web portal presents at least the following information to a user for each order on one or more order detail screens: user name, user location, destination business partner number, destination business partner name, destination store or GLN number, document number, number of containers in each order (number of SSCCs), number of SKUs in each order, number of units of each item in each order, delivery date, any error codes, and status code. A logistics ID number may be used in place of user location. A destination GLN number and business partner name may be found in a table or database. A document number may be found in a user's internal order system. In one embodiment, an ASN web portal can access multiple computer systems and databases. The web portal may calculate the number of SSCCs per order, number of SKUs per order, and number of units per order. A delivery date may be selected from a user's internal order system, or a delivery date may be estimated or suggested by the ASN web portal. An error code may comprise one or more of: a business partner's return code from delivery of the ASN, internal errors associated with validating an order, and any required carrier information. In one embodiment, a status code may comprise one or more of the symbols indicating that: an order is requested for upload, an order is in progress (but not ready for sending an ASN), an ASN is ready to be initiated (where there are no validation errors and all SSCC information is complete), an ASN has been sent, and the order has been stored as a history record.

One or more ASN interface screens allow a user to view and submit actions on more than one order at a time, print any item-to-container details for one or more orders for auditing prior to and after sending an ASN, sort orders by delivery date or other field, filter listed orders by date, and list orders according to user profile information.

In one embodiment, all uploaded item codes on an order must be valid before an ASN may be sent to a business partner. Once valid, the portal displays, saves, and uses the additional data found in the uploaded order which corresponds to known data fields. If the upload file contains a user internal item code or item code case sequence, the web portal may use either the user-specific item information to: (1) match keys of user number and user location found in an order header, (2) match keys of order detail item code or item code-case, (3) display and store item quantity, and (4) use specific GTINs to get valid item data; or, (5) use internal or proprietary item information to display and store the UPC, GTIN, and item descriptions. Similarly, if the upload file contains a GTIN or UPC, the web portal may use internal or proprietary item information to: (1) match keys of order GTIN to get the internal or proprietary item data, (2) display and keep the UPC and item description, and (3) assume that the quantity of each item is one. If a user internal item code does not have a cross-reference, the ASN web portal defaults to listing the UPC code for each item. Optionally, an ASN web portal may indicate to any user that the item code for a particular item is not found and cross-referenced. An uploaded order file may optionally contain a flag to have such indicator active or to suppress such indicator. In different embodiments, an ASN uses either a UPC or a GTIN for each item.

In another embodiment, the ASN web portal validates the user number and user location in each order. The ASN web portal does this by matching keys of the order header, such as user number and user location, to the user profile information previously uploaded and stored by a system administrator on the portal. When validated, the ASN web portal may display the user name, location, address, or other user information such that a user may corroborate that the user was validated. The user profile information is uploaded prior to validating any orders by a web portal administrator. Such information need only be uploaded one time and may be updated at any time. Such uploading may be referred to as onboarding.

Similarly, the ASN web portal validates a business partner number in each order. The business partner number may be a user's internal business partner number. The ASN web portal may display other business partner information upon matching the business partner number with a business partner record previously populated with such information. In one embodiment, such information is found within a business partner masterfile or database. The ASN web portal may read, store and display the department number and GLN number found within an uploaded order file. In another embodiment, a business partner number may be validated against an internal business partner GLN. The business partner department may be read from the uploaded order file.

In another embodiment, an uploaded order file may contain SSCC information. In such case, the ASN web portal does not generate the SSCC information. The company prefix component of each SSCC is validated, and the serial number component is assumed to be valid. All portal-generated SSCCs are unique for at least twelve months.

If an order is shipped via common carrier, an ASN web portal requires that certain carrier-specific information be contained within an uploaded order file or requires a user to input the carrier information into the web portal. In one embodiment, an uploaded order file will contain a destination number instead of a business partner number. In an alternative embodiment, there is a carrier flag (Y or N) within the order file. Such carrier information may include a package code, lading quantity, bill of lading number, carrier code, date, and time. A package code may default to corrugated carton (CTN25). A lading quantity may be determined from other order information. A bill of lading number may be a UCC 17 digit number. A master file of valid carrier codes must be uploaded prior to uploading any order.

In another embodiment, some users may require that an ASN order must have an invoice number which differs from a corresponding order number. In such case, the ASN web portal may generate an invoice number or may scan the uploaded order file for such user-selected invoice number. This invoice number is validated to ensure that the invoice number does not match the order number. The ASN web portal displays the purchase order number for each order uploaded. The portal also allows a user to modify the purchase order number.

### INDIVIDUAL ORDERS

Once an order is successfully uploaded, the ASN web portal may display the details of each order. Such details may not be immediately available after an order file is uploaded. A user may be required to select a link for the web portal to generate, format and display the information. The detailed order information may include the following information from an order's header record: user name, user location, user address, vender order number, user invoice number, order status, purchase order number, internal business partner number or internal destination number, business partner name, business partner address, business partner store number, business partner department, business partner GLN, delivery date, ASN date and time, total SKUs on order, total SSCC and number of containers, and total quantity of saleable units. The detailed order information may also include the following additional order information: internal item number or case sequence number, UPC/GTIN, internal container number, SSCC number, uploaded quantity, item each count, and item description.

An ASN web portal requires a user to assign items from each order to one or more containers for delivery to a business partner such assignment information is not included in a transferred or uploaded order. Such assignment must be done before SSCC labels may be generated and before an ASN may be sent.

In one embodiment and with reference to FIG. 6, header information is summarized on one portion of a screen or form 602, and individual item information is listed on the rest of the screen or form 608. A user assigns each item to a container by entering up to a six digit number into a container field for each item. When a user finishes assigning items to containers, the ASN web portal validates the assignment. The validation includes checking that the sum of the number of units of each item assigned to all containers does not vary from the number of units in the original order. The number of units may have been entered by a user, or uploaded or transferred as part of the order. In another embodiment, a user is able to select and assign more than one item at a time to a particular container.

In another embodiment, a user is able to manually create an order through the ASN web portal. Such creation is in lieu of uploading an order file. A user is required to enter all mandatory header data and all mandatory informafion for each item ordered. After such user keys in the information, the ASN web portal validates the order in a similar manner as for uploaded order files.

### LABELS

Once all validations are passed, and all items are assigned to a container, a user may create SSCC labels through the ASN web portal. Labels may be re-requested as long as an uploaded order is available on the system. The labels may be downloaded as a file and emailed to a supplier for later printing or may be printed directly through the ASN interface.

In one embodiment, an SSCC number is comprised of a 20 digit number. There is one SSCC number for each container, and can be one for the entire order. An SSCC is unique for any given 12 month period. In one embodiment, an SSCC consists of two parts, and digits two through seventeen consist of a unique number. In one embodiment, the first 3 digits are zero. The next seven digits (four through ten) are a unique company prefix number. This prefix number may be a user's EAN.UCC company prefix as assigned by the Uniform Code Council, Inc. The next nine digits (eleven through nineteen) are a unique manufacturer or serial number. Such number is unique across manufacturers. Serial numbers may be re-used for different manufacturers or with the same manufacturer for different destinations or different business partners. The last digit is a check digit wherein, in one embodiment, it is calculated by: (1) from left to right, assigning an odd or even position to each digit; (2) summing all digits in odd positions and multiplying the result by 3; (3) summing all digits in the even position; (4) summing the results of step 3 and step 4; and (5) dividing the result of step 4 by 10. The check digit is the resulting number.

In one embodiment, the nine digit manufacturer or serial number is unique within a user's system, location or company. In another embodiment, the SSCC is unique for twelve months between a manufacturer or user and a business partner or receiving location. At least two of these numbers refer to a unique container number for a given date. In one embodiment, the SSCC is contained within an uploaded order file, while in another embodiment, the SSCC is generated by the ASN web portal. The web portal verifies that each SSCC is valid and unique. If a SSCC is invalid, the web portal generates a new SSCC.

There are several methods for an ASN web portal to serialize an SSCC. One option is to have digits one through nine be a sequential, serialized number managed for each user by the ASN web portal. Such serial number does not contain any embedded information. However, the ASN provides a search of the history of all orders by SSCC or delivery date. Such SSCC is determined by company prefix or location.

Another method for serializing an SSCC is to have digits one through three be a unique identifier for a user's physical location wherein there is an inherent limit of about 999 such locations. Digits four through six are a julienne date wherein there are no digits representing year. Having ajulienne date within an SSCC would allow anyone to determine when an SSCC was generated. Digits seven through nine are true serial numbers for each container with an inherent limit of about 999 containers per location per day. This option allows each user or user location to determine how the SSCC number is calculated: either by the ASN web portal or by the user. Such option also allows traceability by using the information embedded within each SSCC.

Another method for serializing an SSCC is to use digits one through three for a unique identifier for location, digits four through seven for a date (one digit for a year, and three digits for a julienne date), and digits eight and nine as true serial numbers. This method is limited by allowing only 99 unique SSCCs for containers per day. Like the previous option, this option allows each user or user location to determine how the SSCC is calculated: either by the ASN web portal or by the user. Such option also allows traceability by using the information embedded within each SSCC.

Another method for serializing an SSCC is to use the invoice number for serialization. In one embodiment, the first seven digits are a digital document number as read from an order file. The last two numbers indicate container number.

The ASN web portal generates and formats a printable label containing scannable elements. Such label may be printed on a local printer. Such label may also follow a standard SSCC-18 label. Such label may contain such fields as: “ship from” address, “ship to” address, “ship to” postal code, shipping information (e.g. carrier), DSD information (e.g. store number, department number, order number), purchase order number, and SSCC bar code per container. In another embodiment, such label may also contain a description of what is on a given container, any item details, a quantity measurement, a UPC/GTIN description, a UPC bar code, and a manual entry of up to 30 bytes. One or more part of this information may be printed in large letters. Large letters may be easier for a worker to attach the label to the correct container. Such labels may be saved as a report format or in a label format in a user-defined location on a local computer. Such label files may be given a user-defined name.

### ASN COMMUNICATONS

With reference to FIG. 2, the next step in using an ASN web portal is to send an advanced shipping notice 220 to a business partner. The sub-steps of this process include sending ASN information, recording an ASN reply, posting history, and communicating process status and any errors generated during the process.

A user may not initiate the transmission of an ASN communication for an order on an ASN web portal unless prior steps have been completed and validated. In one embodiment, the ASN web portal uses the information contained in a complete and validated order and generates an ASN. The ASN is sent to an EDI gateway wherein the gateway formats the ASN into an EDI 856 transaction and sends it to the business partner. The details of such transaction may include the name of the supplier, the business partner's reference number for the supplier, a purchase order (PO) number, carrier information (bill of lading number, carrier number, lading quantity, and package code), invoice number, store name, store number (GLN), UPC of each item (1-5-5-1 each in UPC format), item description, quantity of each item (each or case), SSCC by container, and order or shipment SSCC. Carrier information and shipment SSCC are optional.

When an EDI 856 order is received, the business partner's system returns an EDI 997 acknowledgement confirming that the ASN was received. Such communication contains information about whether the ASN was in the proper format. If a business partner's system rejects the ASN for invalidly formatted ASN or missing required information, the business partner's system returns an EDI 826 advice to the EDI gateway. Such transaction comprises information about exactly which fields are corrupt or missing. The EDI gateway in turn sends this information to the ASN web portal which then generates and sends an email to appropriate parties using email addresses stored in business partner information and other databases or displays a message on a web portal screen.

Once an ASN is sent, the order record in an order history is updated. Such order or ASN history record may contain two timestamps: one timestamp for when the ASN web portal sends the ASN to the EDI gateway, and the other for the date and time when the EDI 856 transaction was created and returned by the EDI gateway. An order history record may also contain a timestamp from a returned EDI 997 acknowledgement, and an approval status.

ASN order history is preferably retained for ninety to one hundred and twenty days but may be retained longer. Order header information is retained for twelve months and preferably for thirteen months or longer. Other information may be captured and stored as part of history on an ASN web portal such as user ID change history, and status history of orders. In one embodiment, an order may be considered “valid”, “invalid”, “ASN initiated”, “ASN complete”, and “labels printed”. History information may be viewed within security limits and available time ranges. Administrators may have complete access to all history regardless of user identification. Order history may be sorted by supplier name, supplier location, delivery date, item code, or any other field. Order history may be searched by any field within the order header record.

After a certain time, some details of an order record are no longer available for searching. In such case, only certain actions may be taken on these orders such as finding ASN information, re-printing labels, and resending an ASN. The ASN web portal supplies summary data for each order from the order header and presents order details after a designated time has past. Header record details may be downloaded into a spreadsheet for further use such as financial analysis or billing purposes. An ASN web portal may generate order history reports from available order header and other information.

Some users may post retail link reports to the ASN web portal. These reports are viewable by an authorized user. Authorization may be restricted by user, business partner, user location, receiving location, or other criteria. The report information may have a specific number or name by DC location for security purposes. Each retail link report has a header record, a detail record, and a trailer record. A header record may contain such information as: a record header flag, supplier name, supplier location, report name, report version (such as a date), number of versions to retain, and report key description. A detail record may contain such information as: record detail flag, supplier name, supplier location, report name, report version, and report key data. A trailer record may contain a trailer flag, a user name, a user location, a report name, and report version. These retail link reports may be sorted by any field.

Following an ASN transmission to a business partner, a user may enter ASN audit information into the ASN web portal. With reference to FIG. 5, auditing corresponds to step 6 or the audit step 112 in the overall process supported by the web portal. FIG. 11 displays one embodiment of an audit form in which such information may be entered. With reference to FIG. 11, for each order, variations between the order information listed and what is actually within the containers of the shipment may be recorded in a lower region 1116 of the audit form. For each container 1102, and for each product 1104, a user may record either a positive or negative variance 1106, the amount of such variance 1108, the type of error committed 1110, and a note describing the error 1112. Once all audit or variance information is entered, a header section 1114 provides means to complete the auditing step 512 shown in FIG. 5. With reference to the header section 1114, the changes may be saved, the changes may be saved and the form closed, the form may be closed without saving the changes, the details of the form may be printed, and labels may be printed.

Users delivering items to business partners have an audit accuracy rate corresponding to the frequency and quantity of deviations between items actually delivered and the types and amounts of items reported in ASNs.

### ASN WEB PORTAL SETUP

In one embodiment, an ASN web portal initially must be supplied with some item detail data in order to function properly. Such process may be referred to as “on boarding.” Such information may be uploaded in a flat file such as a comma-delimited file. Such item detail data may include user GTIN and UPC codes with descriptions. Such data may be refreshed on a routine basis such as on a daily or weekly basis. A GTIN database record is size 14, and a UPC record is size 12 (in standard 1-5-5-1 format), with corresponding description records of size 45. Users may have a unique internal item numbering scheme. This scheme is uploaded and used to cross-reference the uploaded item codes in an order. Such scheme may contain such fields as: supplier name (size 10), supplier location (size 8), internal item code (size 20), code quantity (arbitrary size), GTIN (size 14), UPC (size 12). The UPC record is considered the saleable unit to a business partner or retailer. The ASN web portal allows an authorized user to upload a new file which updates or over-writes existing item detail data, and which may add additional item detail data.

On boarding also involves uploading initial supplier information. Such initial supplier information includes fields for supplier name (size 10); supplier location (size 8); supplier formal name (size 45); supplier address including two fields for street (size 35), city (size 20), state (size 20), postal code (size 9); upload format type (size 1); uploaded order information flag such as UPC, GTIN, internal item code, SSCC number, or supplier container code (size 1); order number (size 10); contact information for one or more persons including name, several phone numbers, email address, security ID and password; and a blank screen processing flag (size 1). A blank screen processing flag communicates to the ASN web portal whether the portal should automatically validate the order.

On boarding also involves an initial uploading of internal business partner information specific to the supplier. Such information includes one or more GLNs wherein each GLN has a one to many relationship between business partner (one) and user (many). In one embodiment, such information may be uploaded as a flat file, and has such information as: master key type (G for GLN, D for Dunns number, S for chain of the business partner, and T for TD links) (size 1); master key (size 12); business partner store number (size 6); business partner name (size 40); level one chain number (size 1); and business partner address which includes two street fields (size 35), city (size 20), state (size 20), and postal code (size 9). On boarding may also involve uploading other business partner information. Such information may include: retailer level one chain name, level one chain number, and EDI destination code. On boarding also includes uploading of a business partner master file.

With reference to FIG. 6, in one embodiment, an authorized user may filter and display a list of items within any given order in a particular sequence. The ASN web portal maintains a User Item Sequence Table to facilitate such listing. A maintenance screen allows an authorized user to make updates to the information in such table. The ASN web portal may provide a means for an authorized user to upload such a table in the form of a spreadsheet or other type of file. The ASN web portal lists items in sequence first according to supplier name and supplier location. If there are orders which have no location information, these are listed last. The ASN web portal also allows a user to only display certain desired fields from each order. An authorized user or administrator configures which fields are actually displayed. Items within a given order may be listed according to other fields found within the detailed information of each order such as, but not limited to, internal sequencing option (size 2), internal sequence number (size 3), internal sequencing description (size 40), internal item key (size 20), and internal item key type code (size 1). An internal item key type code may be a letter such as “P” for internal item code, “C” for internal case pack, “U” for UPC, and “G” for GTIN.

In one embodiment, the sequenced display of item details within an order is according to a matching method. The ASN web portal uses this method to first match the user name and user location number of each item entry against a User Item Sequence Table. If there is a match on name and location, the ASN web portal checks the internal sequence option, and if it is not “spaces,” the portal allows a user to choose one of the available internal user sequence options with which to display the order details. The ASN web portal presents the supplier sequence options with their corresponding descriptions to facilitate such choice. If there is no match for an item on supplier name and location, items are listed according to the order in which they appeared in the order file as previously uploaded.

In another embodiment, the ASN web portal validates the carrier code master data found within each order. This information is validated against a cross-dock or common carrier delivered order. The carrier code master data may comprise a carrier code (size 4) and a carrier code description (size 25).

The ASN web portal also may validate the supplier name and location found within an uploaded order with the same information associated with the first three digits of the serialized portion of an order's SSCC number. If the order SSCC number must be generated, the ASN web portal uses the next available number as long as the first three digits do not match any other SSCC entry found within the ASN web portal records.

### SOFTWARE ARCHITECTURE

In one embodiment, the ASN web portal is written in Java xJ2EE with the JDK 1.4 or greater (Sun Microsystems, Inc., Santa Clara, Calif.). The ASN web portal uses a commercial relational database such as Oracle® 9.2 or later (Oracle Corp., Redwood Shores, Calif.). However, other databases may be used. Further, the ASN web portal is preferably created with BEA Weblogic® 8.1 or later application server (BEA Systems, Inc., San Jose, Calif.). Other application servers may be used. The ASN web portal and related components preferably run on either an AIX or HPUX operating system in conjunction with an Apache web server version 2.0.48 or later (Apache Software Foundation, Forest Hill, Md.). However, the web portal and related components may be run on any operating system, or combination of systems. In one embodiment, the ASN web portal supports load balancing and may use multiple database servers and application servers. Remote users are required to have an Internet connection and web browser which can access the ASN web portal. In a preferred embodiment, all data flows are secured through SSL transmissions (SSL Certificate Authority, Los Angeles, Calif.).

### SUMMARY

The ASN web portal is capable of uploading and maintaining several different types of data including: security files, masterfile item files, masterfile business partner files, user item cross-reference files, user profile files, user/business partner information cross-reference files, ASN historical data feeds, ASN audit data files, and invoice number files.

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described herein and above is further intended to explain the best mode presently known of practicing the invention and to enable others skilled in the art to utilize the invention as such, or in other embodiments, and with the various modifications required by their particular application or uses of the invention. It is intended that the appended claims be construed to include alternate embodiments to the extent permitted.

We claim:

1. A system for communicating between a plurality of interconnected computers, said system being adapted to send and receive data among said plurality of computers corresponding to at least one user and at least one receiver, said system comprising:
(a) a web server computer;
(b) a receiving computer;
(c) a web portal software application running on the web server computer wherein said web portal software application provides:
(i) a form through which a user sends an order for goods to the web portal software application;
(ii) a form which displays the details of the order for goods;
(iii) a form which displays assignment of goods in the order to individual shipping containers, and through which a user may make adjustments to the assignment of goods to the individual shipping containers; and,
(iv) a form through which a user signals a computer component which then generates shipping container labels.

2. The system of claim 1 wherein said web portal software application further provides a form through which a user transmits an advanced shipping notification for goods from the web portal software application to the receiving computer.

3. The system of claim 1 wherein said web portal software application further provides a form through which a receiver sends an electronic audit communication confirming delivery of goods to the web portal software application.

4. The system of claim 1 wherein said web portal software application further provides a form through which a receiver sends an electronic reporting communication to the web portal software application.

5. The system of claim 1 wherein the receiving computer sends an electronic confirmation of the advanced shipping notification to the web portal software application.

6. The system of claim 1 further comprising:
(d) a database for persisting data and communications between the components of the system whereby the database stores orders, advanced shipping notifications, and labels for at least twelve months.

7. The system of claim 6 wherein the web portal software application provides a search form through which the web portal software application searches information within the database and displays a subset of this information on a form.

8. The system of claim 1 wherein the computer component for printing labels is the web portal software application.

9. The system of claim 1 wherein the order for goods is sent to the web server computer in the form of an order file.

10. The system of claim 1 wherein said advanced shipping notification is in the format of an EDI communication.

11. The system of claim 1 wherein the details of the order for goods comprises: bottler name, bottler location, order number, internal business partner number, business partner destination, business partner GLN, business partner's department code, purchase order number, purchase order date, total header quantity, order delivery date, order delivery time, order invoice number, internal company item number, internal item code, item case, UPC, GTIN, quantity.

12. A method for providing advanced shipping notification through EDI comprising the steps of:
(a) receiving at least one order for items from at least one business partner wherein the order comprises order data of at least (1) item type, (2) item quantity, and (3) business partner identification;
(b) transferring the order data to a web portal software application;
(c) assigning items to at least one delivery container through the web portal software application;
(d) assigning a serialized shipping container code for each of the containers of step (c);
(e) generating labels for each of the delivery containers through a label generating software application;
(f) sending an advanced shipping notification to each of said business partners through said web portal wherein the advanced shipping notification is comprised of the order data; and,
(g) fulfilling the order by delivery of the containers to each of said business partners.

13. The method of claim 12 wherein transferring of the order data of step (b) is uploading the order data to the web portal application.

14. The method of claim 12 wherein the assigning items of step (c) is through a sub-system of the web portal software application.

15. The method of claim 12 wherein the label generating software application of step (e) is a sub-system of the web portal software application.

16. The method of claim 12 further comprising the step of:
(h) receiving an audit communication from each of said business partners wherein the audit communication is comprised of any variances between the quantities or types of goods in the advanced shipping notification and the items delivered to each business partner.

17. The method of claim 12 wherein the label generating software application is the web portal software application.

18. The method of claim 12 wherein the items are goods.

19. The method of claim 12 wherein the order is fulfilled from a plurality of web portal users.

20. The method of claim 16 wherein said business partners treat said plurality of web portal users as one entity.

21. The method of claim 12 wherein the advanced shipping notification is in the format of an EDI communication.
